(19) United States
(12) Patent Application Publication
(10) Pub. No.: US 2015/0194074 A1
(43) Pub. Date: Jul. 9, 2015

(54) CARDIOPULMONARY RESUSCITATION TEACHING SYSTEM AND METHOD

(71) Applicant: INDUSTRIAL TECHNOLOGY RESEARCH INSTITUTE, Hsinchu (TW)

(72) Inventors: Ya-Ling CHEN, Hsinchu City (TW); Yi-Wei SHEN, Pingtung City (TW); Hsing-Chen LIN, Taichung City (TW); Yueh-Hsuan LEE, Hsinchu County (TW)

(73) Assignee: INDUSTRIAL TECHNOLOGY RESEARCH INSTITUTE, Hsinchu (TW)

(21) Appl. No.: 14/459,779

(22) Filed: Aug. 14, 2014

(30) Foreign Application Priority Data
Jan. 8, 2014 (TW) 103100652

(51) Int. Cl. G09B 23/28; G06K 9/46; G09B 5/06

(52) U.S. Cl. CPC G09B 23/288; G09B 5/06; G06K 9/4604

(57) ABSTRACT

According to an embodiment, a CPR teaching system comprises an input device having an image input unit, a hardware processor having an image processing unit and a guidance unit, and an output device, wherein the image input unit captures images and generates a plurality of state image signals; the image processing unit processes state image signals to obtain posture signals and combines the posture signals to generate a trajectory signal; the guidance unit analyzes the trajectory signal to obtain dynamic posture parameters and compares successive dynamic posture parameters to obtain an effectiveness signal, and based on the effectiveness signal to generate at least one feedback instruction; and the output device outputs the feedback instruction, thereby, guiding the user correctly perform CPR.

### CROSS-REFERENCE TO RELATED APPLICATION

The present application is based on, and claims priority form, Taiwan Patent Application No. 103100652, filed Jan. 8, 2014, the disclosure of which is hereby incorporated by reference herein in its entirety.

### TECHNICAL FIELD

The technical field generally relates to a cardiopulmonary resuscitation (CPR) teaching system and method.

### BACKGROUND

The cardiopulmonary resuscitation (CPR) is an important first aid skill to perform on patients who suffers illness or accident resulting in cardiac arrest. Thus, in the shortest possible time after the incident, a bystander, paramedic and medical staff able to appropriately perform CPR in the emergency treatment has become a critical survival or recovery after the injury.

The CPR includes a series of assessment and actions. As the results of the study along with the accumulation of cases, the operation guideline of CPR is also changed. A more effective first aid measurement could be achieved by properly conducting CPR in addition to promote and practice of CPR in the public.

The currently promoted CPR guideline is based on the new CPR operation guideline published by the American Heart Association (AHA). The Ministry of Health of Taiwan also released a version of the CPR Guide based on the above guideline. In the new release, the steps in the old CPR, that is, airway-breathing-compression (A-B-C), are changed to compression-airway-breathing (C-A-B). In the latest CPR Guide, the first step is to perform compression to ensure that the blood circulation of the patient so that the oxygenated blood could reach all the organs. When applying CPR, the technique of chest compression is critical to the effectiveness of the CPR. An effective compression is based on the following criteria: push rates up to 100 times per minute (100 times/min); the absolute compression depth is 5 cm (2 in) for adults and children, and 4 cm (1.4 in) for infants; complete chest restoration (resilient) after each chest compression; avoid interruption of chest compressions; and avoid hyperventilation.

The effectiveness of CPR depends on whether more people could learn and apply the technique properly in emergencies. Therefore, the instruction and related courses for practicing CPR is imperative. The actual practice is a crucial part of the instruction. Hence, it is desirable to devise an effective application instruction system. In particular, with limited number of qualified instructors for CPR to go around and give classes, a teaching system with audiovisual-assisted instruction could fill the gap between the demand and the supply of CPR learning.

The known CPR teaching system typically includes a dummy and a platform for audiovisual guidance. The dummy is to simulate the patient in need of resuscitation. This audiovisual guidance platform includes a display, a speaker, and a multimedia device. The audiovisual guidance platform is for recording and playing a multimedia instruction content for teaching users. T multimedia instruction content includes audiovisual guidance to instructor a user to practice CPR on the dummy. Among the techniques, the most difficult part for the user to learn is the chest compression. Therefore, the known interactive CPR teaching system typically uses a motion-sensing technology to record the information of the user operation and then a microprocessor to analyze the information to transmit to the audiovisual guidance platform for output to provide further guidance to the user so that the user is informed in real time for adjusting operation.

The known interactive CPR teaching system is based on an optical sensing technology, and uses a light-ball sensing device. When the user operates the system, the system needs a light-ball device to emit the signal to enable a sensing device to detect the signal and perform subsequent processing. Therefore, the system could often affect the effect the operation in actual simulation as well as expensive due to the inhibitive cost of the light-ball device.

### SUMMARY

The embodiments of the present disclosure may provide a cardiopulmonary resuscitation (CPR) teaching system and method.

An exemplary embodiment relates to a CPR teaching system. The CPR teaching system may comprise an image input device having an image input unit, a hardware processor having an image processing unit and a guidance unit, and an output device. The image input unit detects and captures a plurality of dynamic images of a user performing a chest compression, and generates a plurality of state image signals. The image processing unit is coupled to the image input module, receives and processes the plurality of state image signals obtained by the image input unit, transforms the plurality of state image signals into a plurality of posture signals after an analysis computation, and then integrates the posture signals into a trajectory signal. The guidance unit is coupled to the image processing module, receives the trajectory signal from the image processing unit, analyzes on the trajectory signal to obtain a plurality of dynamic posture parameters, and further on the plurality of dynamic posture parameters to obtain an effectiveness signal, and provides a feedback instruction based on an analyzed result of the effectiveness signal. The output device is coupled to the guidance unit, receives the feedback instruction and outputs the feedback instruction, thereby guiding the user to operate the chest compression correctly.

Another exemplary embodiment relates to a CPR teaching method, applicable to a CPR teaching system having an image input device, a hardware processor having an image processing unit and a guidance unit, and an output device. The method may comprise: receiving, by the image input device, a series of state images of a user; setting, by an interface to the CPR teaching system, a continuous duration; using the hardware processor to position the user's palms and obtain a plurality of feature points of the series of state images, and based on the plurality of feature points, and perform an analysis computation to obtain a posture signal and a trajectory signal; based on the trajectory signal, using the hardware processor to obtain an effectiveness signal, and determine the effectiveness signal according to a stand to identify whether a compression is an effective compression; and using the hardware processor to compute a number of effective compressions in the continuous duration, and generate at least one feedback instruction.

Yet another exemplary embodiment relates to a CPR teaching system. The CPR teaching system may comprise a hardware processor and a memory device. The memory device stores a plurality of executable instructions. The hardware processor executes the plurality of executable instructions to perform: receiving, by an image input device, to a plurality of dynamic images of a user; using an interface to configure a plurality of system parameters and standard values and wait for the user in a ready state; when not completing to positioning a palm of the user, executing a palm positioning analysis until positioning the palm of the user being completed; entering an actual practice and timing phase, wherein the actual practice and timing phase is, for a predefined continuous duration, synchronously and continuously monitoring an operation of the user; in the predefined continuous time, when the user stopping a chest compression operation, giving at least one feedback instruction indicating a failure and terminating the actual practice and timing phase; and otherwise, continuing monitoring until a number of compressions being reached or a predefined continuous duration being expired.

The foregoing will become better understood from a careful reading of a detailed description provided herein below with appropriate reference to the accompanying drawings.

### BRIEF DESCRIPTION OF THE DRAWINGS

FIG. 1 shows a schematic view of the structure of a CPR teaching system, in accordance with an exemplary embodiment.

FIGS. 2A-2I show schematic views of the image processing unit and the guidance unit executing process, in accordance with an exemplary embodiment.

FIG. 3 shows a schematic view of a palm motion trajectory simulation, in accordance with an exemplary embodiment.

FIG. 4 shows an operation flow of a CPR teaching method, applicable to a CPR teaching system, in accordance with an exemplary embodiment.

FIG. 5 shows a flowchart of the detailed operations of step 404 of FIG. 4, in accordance with an exemplary embodiment.

FIG. 6 shows a flowchart of the detailed operations of step 407 of FIG. 4, in accordance with an exemplary embodiment.

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The CPR teaching equipments used in the CPR teaching system and method disclosed in the following, such as, the dummy and related devices to measure and assess the airway (A) step and breathing (B) step, processing device, display device, and so on, are realized by known techniques and detailed descriptions are omitted in the following disclosure.

The CPR teaching system in the disclosure targets at the chest compression (C) step set forth in the AHA guideline published in 2010, and details will not be included here.

In addition, because the total number of compression in the chest compression step is a critical factor affecting the effectiveness of the resuscitation and the higher the number of compressions, the higher the survival rate. The number of compression is determined by compression rate and compression duration. On the other hand, the compression depth determines whether a compression could effectively improve chest pressure to pump the blood for circulation other organs. Therefore, the compression rate and compression depth are important factors in the chest compression step. The following shows the assessment basis for the quality of the chest compression in the present disclosure:
1. compression rate must reach 100 times per minute (100 time/min);
2. compression depth (absolute compression depth) must reach 5 cm;
3. the chest must be fully restored (i.e., rebound by resilience) after each compression; and
4. compression must not be interrupted.

The disclosure is based on the above criteria to assess whether the user practicing the chest compression satisfies the criteria and to generate respective feedback instruction to guide the user to perform correct chest compression.

The standard values adopted in the disclosure is based on the current suggested guidelines, and could be adjusted when new guidelines surface to improve teaching result. In addition, the exemplary embodiment in the disclosure is targeting the operation on adult. Corresponding guidelines must be consulted when applying to other patients, such as, children for infants.

The terminology couple/coupled/coupling refers to any direct or indirect connection means. For example, when a first device is described to be coupled with a second device, the interpretation of the above statement should be read as the first device is directly connected to the second device, or the first device is indirectly connected to the second device through other device or a certain connection means.

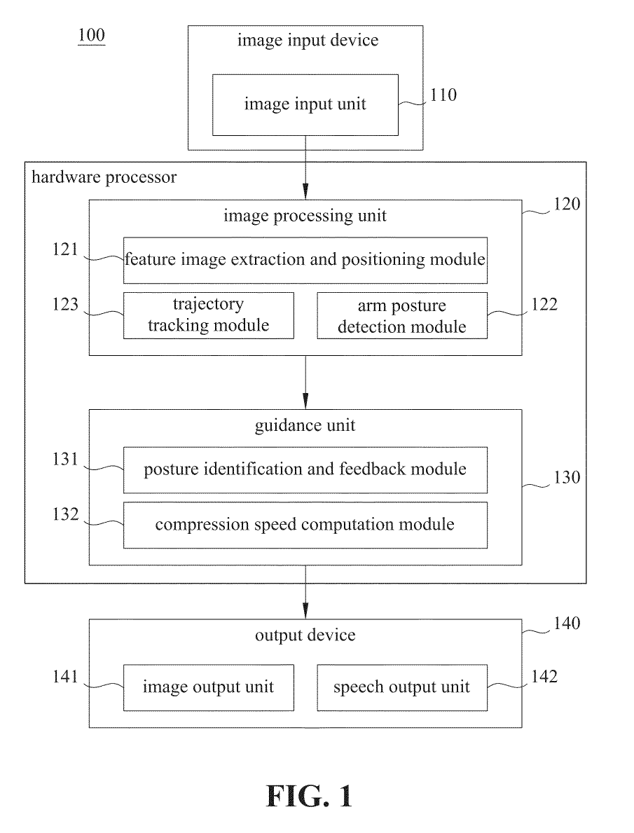

FIG. 1 shows a schematic view of the structure of a CPR teaching system in accordance with an exemplary embodiment. As shown in FIG. 1, the CPR teaching system 100 may comprise an image input device having an image input unit 110, a hardware processor having an image processing unit 120 and a guidance unit 130, and an output device 140. The image input unit 110 detects and captures a plurality of dynamic images of a user performing a chest compression, and generates a plurality of state image signals. The image processing unit 120 is coupled to the image input unit 110, receives and processes the plurality of state image signals obtained by the image input unit 110, transforms the plurality of state image signals into a plurality of posture signals after an analysis computation, and then integrates the plurality of posture signals into a trajectory signal. The guidance unit 130 is coupled to the image processing unit 120, receives the trajectory signal from the image processing unit 120, analyzes on the trajectory signal to obtain a plurality of dynamic posture parameters, and further on the plurality of dynamic posture parameters to obtain an effectiveness signal, and provides a feedback instruction based on an analyzed result of the effectiveness signal. The output device 140 is coupled to the guidance unit 130, receives the feedback instruction and outputs the feedback instruction, thereby guiding the user to operate the chest compression correctly.

The image input unit 110 detects the dynamic images when the user performs the chest compression step. The detection target is the motion change when the user performs the chest compression, especially, the changes of both arms and both palms. The image input unit 110 could obtain continuous state image signals during detection, or a plurality of state image signals according to predefined time intervals or time durations.

The image processing unit 120 is coupled to the image input unit 110. After the image input unit 110 obtains the state image signals, the image input unit 110 transmits the state image signals to the image processing unit 120 to perform analysis and computation, and transform the state image signals to the posture signals. According to an exemplary embodiment, the posture signals refer to palm position signals and feature point signals. The image processing unit 120 then proceeds to perform further analysis and computation so that the posture signals could be integrated into a trajectory signal. The trajectory signal is the dynamic trajectory when the user performing chest compression in a specific continuous duration. According to an exemplary embodiment, the trajectory signal refers to a palm trajectory signal. In other words, the motion trajectory of the user's palm in the specific continuous duration.

The guidance unit 130 is coupled to the image processing unit 120. After the guidance unit 130 receives the trajectory signal from the image processing unit 120, performs analysis and computation on the trajectory signal and obtains a plurality of dynamic posture parameters. According to an exemplary embodiment, the guidance unit 130 may use such as a peak detection algorithm to distinguish the threshold, peak and valley of the trajectory signal, which are the dynamic posture parameters of the present disclosure. The dynamic posture parameters could change in real time as the user performs the chest compression. Then, the guidance unit 130 performs execution analysis on the dynamic posture parameters to obtain an effectiveness signal. In an exemplary embodiment, the effectiveness signal is the compression depth of each compression.

Accordingly, based on the operation guidelines, the default standard used by the present disclosure includes: a compression depth of 5 cm, and the compression speed reaches 100 times/min. Therefore, the guidance unit 130 inspects in the analysis whether the effectiveness signal meets the standard (i.e., at least 5 cm in compression depth), and if so, the guidance unit 130 determines the compression as an effective compression. Then, the guidance unit 130 also counts the number of effective compressions in a preset continuous duration to obtain the number of compressions and compression speed. After obtaining the above analysis and determining a result, the guidance unit 130 could generate at least a feedback instruction accordingly, such as, succeed or fail.

The output device 140 is coupled to the guidance unit 130 so that the feedback instruction from the guidance unit 130 is passed to the output device 140 for outputting the feedback response to guide the user to correctly perform chest compression if required. According to an exemplary embodiment, the feedback instruction could be in a speech, image or other multimedia form to enhance the teaching and learning so that the user may learn whether the chest compression performance meets the standard. In addition, the present disclosure imposes no specific restriction on the embodiment of the output device 140. An embodiment is to use the available audiovisual output devices without additional hardware cost. During outputting, the output device 140 may further provide additional guidance or suggestion, such as, encouragement or correctional suggestions, based on the feedback instruction to further enhance the learning.

The following description of modules of the system, or the functional units or corresponding features and effect also refers to the exemplary embodiment in FIG. 1.

The image input unit 110 refers to any depth image camera that is able to detect the dynamic changes in a target object (for example, a human body in one exemplar of the present disclosure). The main function of the image input unit 110 is to continuously capture the human body dynamic images and the corresponding image depth signals. Therefore, no specific restriction is imposed on the depth image camera used in the present disclosure. According to an exemplary embodiment, the image input unit 110 could be Kinect depth-sensing camera (Microsoft), Xtion (ASUS), or other equivalent depth image camera (sensors). Because the depth-sensing technology in the embodiment is a commonly known technique, the details will be omitted. In other words, the detection technique is based on light coding, which uses an infrared light source to generate and broadcast signal to mark objects in a space to obtain measurement information. After coding and computation, a 3D depth image of the detected target could be obtained and the depth information could be further transformed into 3D image. In addition to the Kinect depth-sensing camera or Xtion depth-sensing camera, a high resolution color camera (such as, 720p color camera) could also be used to enhance the performance of capturing image information.

Therefore, based on the depth-sensing camera, the user and the dummy for chest compression practice in the present embodiment are not required to wear any controller or transmitter, such as light-ball equipment, to achieve detection effectively. Thus, no additional hardware will interfere with the user performing chest compression practice so as to improve the realism of the learning.

The image processing unit 120 of the present disclosure is for analyzing the depth information of the dynamic images. The technical base of the image processing unit 120 is still related to the depth-sensing camera. In addition to image depth detection, the depth-sensing camera is also able to track and focus as well as perform skeletal tracking. As such, the image processing unit 120 could be used to monitoring and tracking the user dynamic state and obtain required information of the motion change when the user performs the chest compression.

Specifically, the image processing unit 120 of the present disclosure uses the aforementioned skeletal tracking technique to identify the body feature points of the user, in particular, the arms and palms, and detects the dynamic states of the body feature points. Then, by monitoring the body feature points, the motion change of specific body areas, such as, palms, could be tracked to specify the hand feature points to obtain the state image signals of the hand feature points, called hand state image signal in the following description. Because the depth-sensing and skeletal-tracking are known techniques, the details will be omitted in the description.

The image processing unit 120 further includes a feature image extraction and positioning module 121, an arm posture detection module 122 and a trajectory tracking module 123. The feature image extraction and positioning module 121 of the image processing unit 120 is based on skeletal information to identify the hand feature points of the user and obtains the hand state image signals for performing positioning. Furthermore, the hand feature points are further used to performing positioning of the palms of the user performing the chest compression. The arm posture detection module 122 monitors the arm posture of the user. When obtaining the position information of the hand feature points, the trajectory tracking module 123 performs tracking the palms of the user and analyzes the trajectory change of the hand feature points.

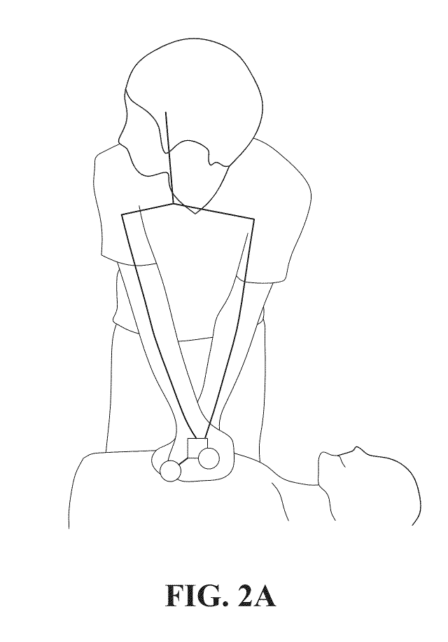

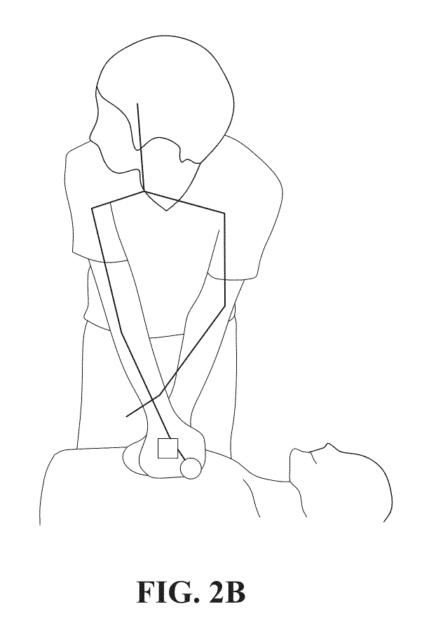

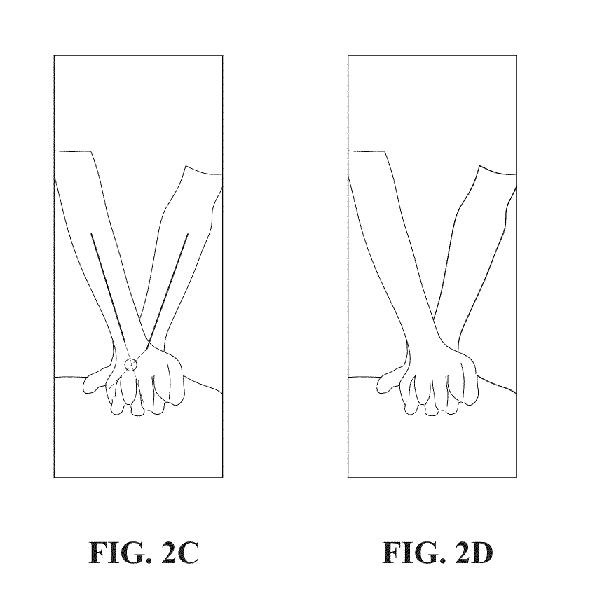

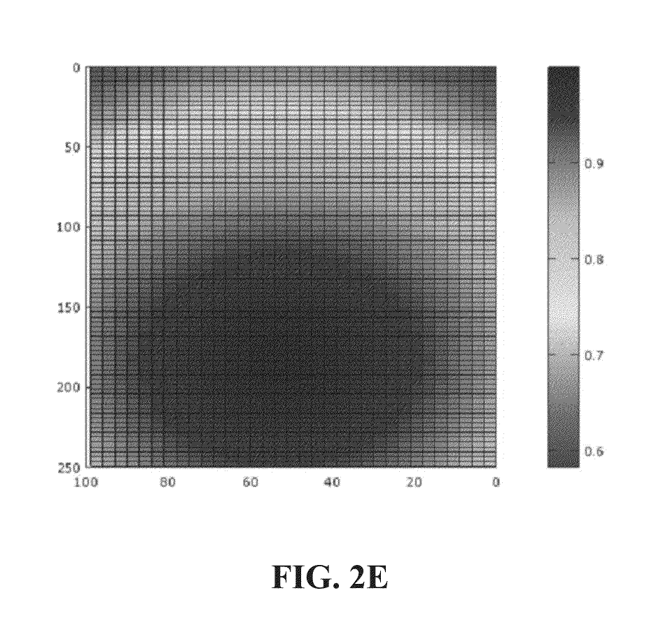

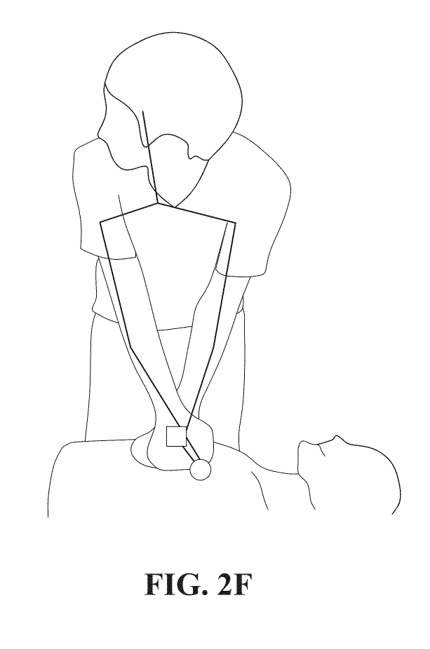

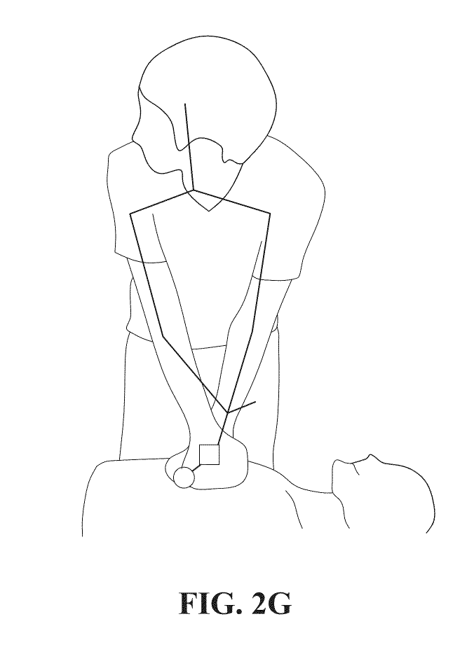

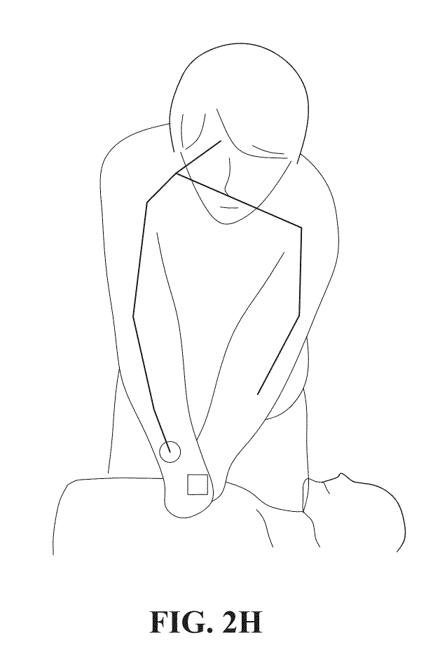

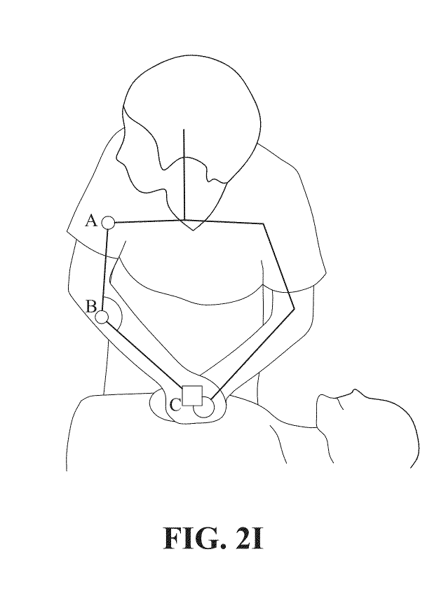

FIGS. 2A-2I show schematic views of the image processing unit and the guidance unit executing process in accordance with an exemplary embodiment.

Specifically, when positioning the palms of the user, the image processing unit 120 may suffer the image shielding caused by skeletal overlapping problem if a conventional technique is used for positioning because the palms are overlapped when the user performs chest compression. As a result, the conventional positioning technique will cause the incorrect reading of the palm positions so that the subsequently computed nodes and actual palm position do not match. The palm position is not stable, as shown in FIGS. 2A-2B. FIGS. 2A-2B are consecutive images of a fixed posture. The circle in the figures indicates the palm position determined by the original image processing module. Because the left palm is shielded, the determined palm position of the left palm in FIG. 2A deviates from the actual palm position, and the palm position of the left palm could not be detected in FIG. 2B. As seen in FIGS. 2A-2B, the detected palm positions from the consecutive images of a fixed posture are not stable and are not suitable for recoding palm compression trajectory when performing chest compression.

Regarding this issue, the present disclosure provides the following solution. To define the palm position correctly, the first step is to find the elbow and the forearm direction of the user and extracts the image of the sub-area, as shown in FIG. 2C. Because the palm overlapping area shows great image change, the gradient is used to find the possible palm area. The image gradient could be determined as follows:

$$∇ f ( x , y ) = \frac{\partial f ( x , y )}{\partial x} d x + \frac{\partial f ( x , y )}{\partial y} d y \qquad ( 1 )$$

The obtained image gradient is shown in FIG. 2D.

Because the area with largest image gradient is not necessary the palm area, the original skeletal information is used to calibrate the palm position more accurately. First, the intersection point of the two extended lines of elbow-to-wrist is found, indicated by the circle with coordinates (InitHandCenterX, InitHandCenterY) in FIG. 2C. A function P is generated by the point:

$$P ( x , y ) = {e}^{\frac{- {( x - InitHandCenterX )}^{2}}{{σ}_{x}}} \cdot {e}^{\frac{- {( y - InitHandCenterY )}^{2}}{{σ}_{y}}} \qquad ( 2 )$$

Wherein σₓ and σ_{y} are the sensitivities along the x and y directions respectively, and the higher the sensitivity value is, the sensitivity change in that direction will be. FIG. 2E shows a view of the mapping of P function, with value 1 indicating most likely the location of the palm position. Finally, combining the above (1) and (2), the function Hand_{likelihood} could be expressed as:

$${Hand}_{likelihood} ( x , y ) = P ( x , y ) \cdot \frac{1}{1 + {e}^{\frac{( ∇ f ( x , y ) - {m}_{f} )}{{σ}_{f}}}} \qquad ( 3 )$$

Wherein m_{f} is for setting the normalized alignment center, and σ_{f} is the gradient sensitivity. The higher the value is, the lower the effect by the gradient on the image will be. Finally, the position of the maximum value in function Hand_{likelihood} is considered as the calibrated palm position, as shown in FIG. 2F and FIG. 2G, where the squares indicates the correct palm position.

The calibrated palm position is then combined with the trajectory tracking unit to track the palm trajectory, as shown in FIGS. 2F-2H. The original skeletal tracking of the image module could not effectively keep track of the palm position correctly and dynamically, but the calibrated algorithm could effectively and stably track the palm position (shown as the square in the figures).

When tracking hand feature points, the computation load must be high and the efficiency would be low if the full-frame image obtained by the image input unit 110 is used for tracking, which also affects subsequent signal processing performance. Therefore, another embodiment of the present disclosure provides a solution. The image processing unit 120 could find the pixel computation feature points for further computation and tracking, where the pixel computation feature points are representative and correspond to the palm area according to the color image information. As such, an exemplary embodiment is to use speeded up robust features (SURF). The rationale is that SURF is invariant under the rotation and zooming. When performing chest compression in CPR and pressing the palms in rapid motions, the features could be maintained. Therefore, SURF searches the pixel point x=(x,y) in the feature mage to compute feature point. At this point, the Hessian matrix H(x, σ) of zoom factor σ is first computed:

$$H ( x , σ ) = [ \begin{matrix}{L}_{xx} ( x , σ ) & {L}_{xy} ( x , σ ) \\ {L}_{yx} ( x , σ ) & {L}_{yy} ( x , σ )\end{matrix} ] \qquad ( 4 )$$

Wherein Lₓₓ(x, σ) is a convolution of a Gaussian 2^{nd}-order derivative

$$\frac{{\partial }^{2}}{\partial {x}^{2}} g ( σ )$$

and a center point x of the hand feature image I, and L_{xy}(x, σ) and L_{yx}(x, σ) have the similar definition. Then, the hessian matrix is simplified and approximated:

det(Hₐₚₚᵣₒₓ)=DₓₓD_{yy}−(0.9D_{xy})² (5)

Wherein Dₓₓ, D_{xy} and D_{yy} are approximations of Lₓₓ, L_{xy} and L_{yy}, respectively, and det(Hₐₚₚᵣₒₓ) is the approximate matrix of det(H).

Finally, the pixel computation feature value is computed. If the feature value of the point is greater than the default pixel computation threshold, the point is considered as a representative pixel computation feature point in the image. As such, the palm or other specific part, called SURF feature point, in the hand feature image could be lock-in for analysis computation, and the computation efficiency is improved.

Besides, when tracking hand feature points, the palm positioning must be continuously identified for tracking purpose. Therefore, to continuously lock-in the palm position in dynamic images, the present disclosure uses optical flow algorithm to track hand feature points; by inducing the palm motion speed and direction according to the pixel strength change along the time, the palm position change could be obtained. The dynamic palm position change information indicates the posture change of the palm posture. The trajectory of palm motion in a specific continuous duration could be recorded and analyzed with further integration computation and analytic technique.

Up to this point, the units of the image processing unit 120 could perform analysis and computation to transform the generated signals corresponding to dynamic change in the hand feature image into posture signals representing the hand posture change, and then an integrated computation technique is used to transform the dynamic posture signals into a trajectory signal.

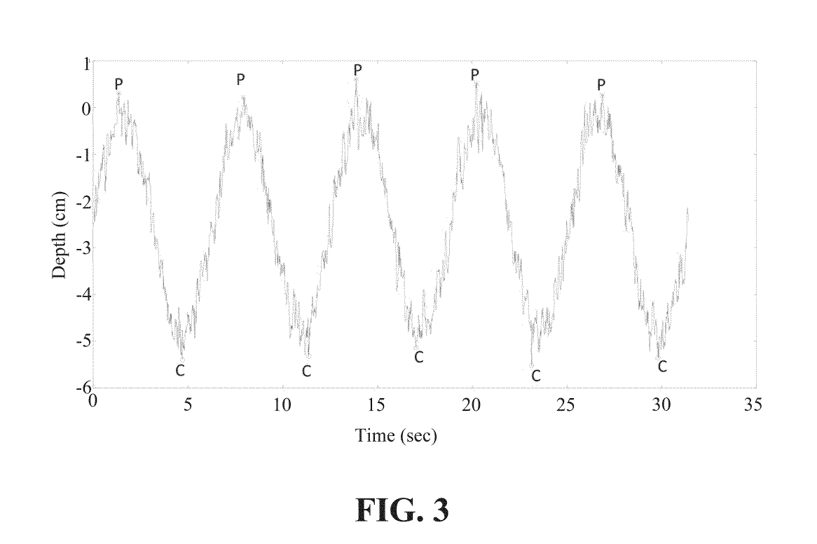

The guidance unit 130 further includes a posture identification and feedback module 131 and a compression speed computation module 132. The posture identification and feedback module 131 and the compression speed computation module 132 collaborate in performing trajectory analysis according to the trajectory signal outputted by the image processing unit 120, and compute the compression depth, number of compressions and compression speed according to the analysis result. In an exemplary embodiment, a peak detection algorithm is used for analysis. Refer to FIG. 3, FIG. 3 shows a schematic view of a palm motion trajectory simulation in accordance with an embodiment, wherein the wavy curve depicts the palm motion trajectory, indicating the palm trajectory signal in a specific duration. Specifically, as shown in FIG. 3, according to the analysis information outputted by the image processing unit 120, the motion trajectory of user's palms in a specific continuous duration is known, and then the peak detection algorithm is used to detect the positions of local peak and valley and defines a threshold. The threshold is to prevent the error reading caused by the noise in the signal. Then, the algorithm continues to search for a peak P, and a locally found maximum value is recorded and defined as the local maximum. The value of local maximum subtracted by the threshold (i.e., [local maximum−threshold]) is computed. Then, when the found value is less than [local maximum−threshold], the local maximum is considered as a peak value. Then, the algorithm continues to search for a valley, and a locally found minimum value is recorded and defined as the local minimum. The value of local minimum plus the threshold (i.e., [local minimum+threshold]) is computed. Then, when the found value is greater than [local minimum+threshold], the local minimum is considered as a valley value C. Repeat the above algorithm to search fro the peaks and valleys until the entire trajectory signal is inspected. The computation of the compression depth is determined by inspecting the difference between the neighboring peak value and valley value.

According to the result of the compression depth computation, the inspection of the difference between peak and valley values could be used to determine whether the compression depth meets the standard (i.e., 5 cm). When the compression meets the standard of 5 cm, the compression is counted as an effective compression. Otherwise, the system does not count the compression as an effective compression. As such, the number of effective compressions within a fixed continuous duration is counted to know the compression speed.

The system of the present disclosure, in addition to performing tracking and computation on the palm motion trajectory, uses the arm posture detection module 122 of the image processing unit 120 to simultaneously monitor the arm posture and outputs an information to the posture identification and feedback module 131 of the guidance unit 130. The posture identification and feedback module 131 could preset a standard for a abnormal posture sensitivity parameter, and computes on the information provided by the arm posture detection module 122 according to the preset standard of the abnormal posture sensitivity parameter to identify whether the arm posture of the user during chest compression meets the preset standard so that the guidance unit 130 may provide corresponding feedback instruction (such as, incorrect posture, correct posture) to guide the user to perform chest compression with correct arm posture to improve the effectiveness of learning. The related monitoring and analysis techniques are described as follows. The posture sensing unit will computes the bending of the elbow. If the bending is less than a preset threshold, a warning will be issued, as shown in FIG. 21. Take the right arm as example. Point A is the right shoulder, point B is the right elbow and point C is the calibrated palm position. The elbow bending angle θ could be computed as follows:

$$θ = {cos}^{- 1} \frac{\vec{AB} \times \vec{BC}}{‖ \vec{AB} ‖ ‖ \vec{BC} ‖} \qquad ( 6 )$$

The left elbow bending angle could also be obtained by the same equation. When either left or right elbow bending angle θ is less than a preset threshold, a warning is issued to the user.

The output device 140 further includes an image output unit 141 and a speech output unit 142. The output device 140 coupled to the guidance unit 130 outputs the feedback instruction provided by the guidance unit 130 to guide the user to perform chest compression accurately. The image output unit 141 outputs static and/or dynamic images, and could play specific images according to the feedback instruction, such as, chest compression succeeded, chest compression failed, arm posture correct, arm posture incorrect, and so on, so that the user could learn from the images. On the other hand, the speech output unit 142 outputs a speech instruction, and the speech instruction could be used in combination with the image output or independently so that the user may concentrate on performing chest compression without viewing the image output. The output device 140 of the present disclosure could be realized with the available audiovisual equipment without purchasing new hardware, which further reduces the cost.

Besides the feedback instructions provided by the guidance unit 130, the output device 140 could also provide additional guidance suggestions according to the feedback instruction. For example, when the user reaches the target, an encouragement audiovisual an be played; or, when the user fails, the reasons are listed, such as, insufficient compression depth, insufficient compression speed, incorrect arm posture, and so on, and even with further specific guidance, such as, specifics on compression depth, correct arm posture and compression speed.

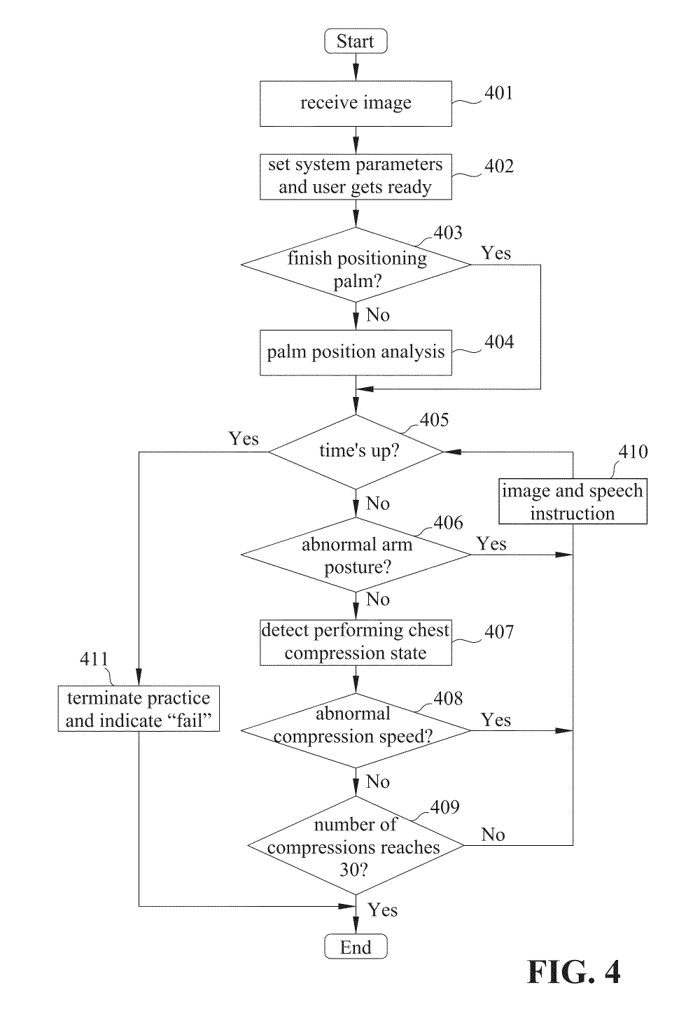

FIG. 4 shows an operation flow of a CPR teaching method, applicable to a CPR teaching system, in accordance with an exemplary embodiment. As shown in FIG. 4, step 401 is to use an image input device to receive state images of a user. Step 402 is to set system parameters and standards, such as, compression depth and abnormal posture sensitivity parameter, and so on, for system analysis and computation; and the user gets ready for performing chest compression on the dummy.

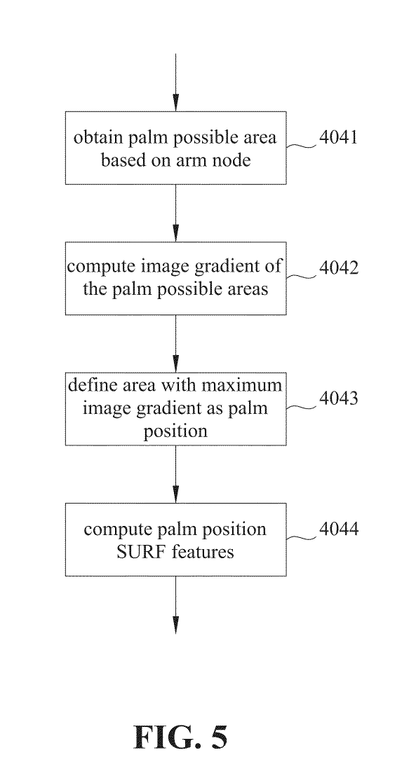

When the user is ready, the system starts to execute step 403 to position and track the user's hand (including arm and palm) and perform analysis and computation to confirm whether the CPR teaching system finishes the positioning the palm; if not, proceed to step 404; otherwise, proceed to step 405. Step 404 is to use the aforementioned palm position analysis and computation method to correctly identify the palm position. FIG. 5 shows a flowchart of the detailed operation of step 404 of FIG. 4, in accordance with an exemplary embodiment. As shown in FIG. 5, step 4041 is to find the direction of the elbow-to-forearm of the user and extend along the direction to find possible position and area of the palm Step 4042 is to compute the image gradient of the possible palm position. Step 4043 is to find the position and area with a highest image gradient and define the position and area with the highest image gradient as the palm area. After obtaining palm positioning information, step 4044 uses the SURF technique to compute the SURF feature points of the palm in a more efficient computation manner. After achieving steps 4041-4044, the system proceeds to the actual testing of step 405.

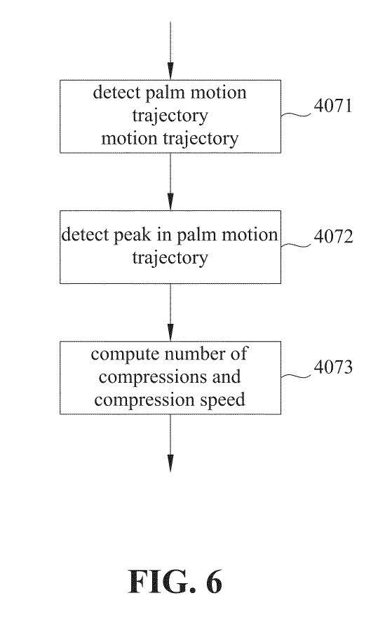

Step 405 is to time a preset continuous duration, such as 1 minute. During the continuous duration, the system monitors continuously in real time the operation of the user, including the palm tracking and palm motion trajectory analysis and arm posture monitoring and analysis to provide feedback instruction in subsequent steps. In the continuous duration in step 405, if the user stops compressions in the middle, the measurements of compression depth, number of compressions and compression speed will be reflected in the system, which will give a feedback instruction to indicate “fail”, and step 411 will output the feedback instruction to indicate fail. On the other hand, if the user continues, the system enters step 406 to monitor and determine whether the arm posture is correct. If the result of the monitoring leads to a feedback instruction to indicate “arm posture abnormal”, the system executes step 410 and outputs images and speech guidance to guide the user to correct the posture; otherwise, the system executes step 407 to detect the chest compression performed by the user. FIG. 6 shows a flowchart of the detailed operation of step 407 of FIG. 4. As shown in FIG. 6, step 407 further includes steps 4071-4073. Step 4071 is to use optical flow algorithm to track hand feature points and obtain the posture signal of the dynamic change information of the palm position and analyze the palm motion trajectory during the specific continuous duration to generate the trajectory signal. Step 4072 is to perform analysis on the trajectory signal, by using such as a peak detection algorithm to compute the peak of the palm motion trajectory, obtaining the compression depth and determining whether each compression is effective. Step 4073 is to count the number of effective compressions to obtain the compression speed in the continuous duration.

After obtaining number of compressions and compression speed, the CPR teaching system executes step 408 to determine whether the compression speed meets the preset standard; and if not, the CPR teaching system executes step 410 to give a feedback instruction and output images and speech to warn the user; otherwise, when the compression speed meets the preset standard, the CPR teaching system continues monitoring until the number of compressions reaches the preset standard, such as, 30 times, as shown in step 409.

In other words, according to an exemplary embodiment, the CPR teaching method may comprise: receiving, by the image input device, a series of state images of a user; setting, by an interface to the CPR teaching system, a continuous duration; using the hardware processor to position the user's palms and obtain a plurality of feature points of the series of state images, and based on the plurality of feature points, and perform an analysis computation to obtain a posture signal and a trajectory signal; based on the trajectory signal, using the hardware processor to obtain an effectiveness signal, and determine the effectiveness signal according to a stand to identify whether a compression is an effective compression; and using the hardware processor to compute a number of effective compressions in the continuous duration, and generate at least one feedback instruction.

Therefore, the CPR teaching system and method according to the exemplary embodiments may identify and analyze in real time the user's performance in the chest compression and give at least one feedback instruction to provide suggestions or warnings, thereby the user may continue the learning or correct the incorrect posture. More features of the present disclosure are such as, by using depth-sensing camera to obtain upper arm skeletal data and using algorithm to position the palm feature points, and tracking palm motion trajectory to determine the chest compression depth and frequency to ensure the accuracy of CPR practice.

According to the exemplary embodiments of the disclosure, the aforementioned CPR teaching method may use the interface to the CPR teaching system to configure system parameters and standard values and wait for the user in a ready state. When the CPR teaching system does not complete positioning the palms of the user, the CPR teaching system may perform a palm positioning analysis until complete the positioning the palms of the user. The CPR teaching system then enters an actual practice and timing phase, wherein the actual practice and timing phase is, for a predefined continuous duration, the CPR teaching system synchronously and continuously monitoring the operation of the user, which including the tracking and trajectory analysis of the palm motion, and monitoring and analysis of the arm posture for providing feedback instruction in subsequent steps. In the predefined continuous time, when the user stopping the chest compression operation, the CPR teaching system may give at least one feedback instruction indicating a failure and terminating the practice.

During the predefined continuous duration, the CPR teaching system may monitor and determine whether the arm posture is correct. When the arm posture is not correct; the CPR teaching system may give at least one feedback instruction indicating incorrect arm posture, and outputting an image accompanied by at least one audio instruction to warn the user. After obtaining information of number of compressions and a compression rate, the CPR teaching system may determine whether the compression rate satisfying a predefined standard value. When the compression rate does not satisfy a predefined standard value, the CPR teaching system may output an image accompanied by audio instruction to warn the user; otherwise, the CPR teaching system continues monitoring until the number of compressions is reached or the predefined continuous duration is expired.

According to another exemplary embodiment of the present disclosure, the CPR teaching system may comprise a hardware processor and a memory device. The memory device may store a plurality of executable instructions. The hardware processor may execute the plurality of executable instructions to perform: receiving, by an image input device, to a plurality of dynamic images of a user; using an interface to configure a plurality of system parameters and standard values and wait for the user in a ready state; when not completing to positioning a palm of the user, executing a palm positioning analysis until positioning the palm of the user being completed; entering an actual practice and timing phase, wherein the actual practice and timing phase is, for a predefined continuous duration, synchronously and continuously monitoring an operation of the user; in the predefined continuous time, when the user stopping a chest compression operation, giving at least one feedback instruction indicating a failure and terminating the actual practice and timing phase; and otherwise, continuing monitoring until a number of compressions being reached or a predefined continuous duration being expired.

As mentioned earlier, the synchronously and continuously monitoring the operation of the user may include the tracking and analyzing a palm motion trajectory analysis, and monitoring and analyzing the arm posture for providing at least one feedback instruction in at least one subsequent step. During the predefined continuous duration, the hardware processor may further perform: monitoring and determining whether an arm posture being correct; when the arm posture not correct, giving a feedback instruction indicating an incorrect arm posture, and outputting a state image accompanied by an audio instruction to warn the user; after obtaining an information of the number of compressions and a compression rate, determining whether the compression rate satisfying a predefined standard value; and when the compression rate not satisfying a predefined standard value, outputting the state image accompanied by the audio instruction to warn the user.

In summary, according to the exemplary embodiments, the CPR teaching system and method may identify and analyze in real time the user's performance in chest compression and gives at least one feedback instruction to provide suggestions or warnings so that the user may continue the learning or correct the incorrect posture. The present disclosure also provides a CPR teaching system with simplified equipment and higher simulation result at a reduced cost. The system is easy to operate and good for public promotion of CPR training. The present disclosure further provides a CPR teaching system able to track the user operation in real time. During monitoring, the user's arm posture is identified as correct or incorrect through image identification and analysis, and suitable guidance is provided to the user to enhance the learning.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A cardiopulmonary resuscitation (CPR) teaching system, comprising:
an image input device having an image input unit, wherein the image input unit detects and captures a plurality of dynamic images of a user performing a chest compression, and generates a plurality of state image signals;
a hardware processor, further including:
an image processing unit coupled to the image input unit, wherein the image processing unit receives and processes the plurality of state image signals obtained by the image input unit, transforms the plurality of state image signals into a plurality of posture signals after an analysis computation, and integrates the plurality of posture signals into a trajectory signal; and
a guidance unit coupled to the image processing unit, wherein the guidance unit receives the trajectory signal from the image processing unit, analyzes on the trajectory signal to obtain a plurality of dynamic posture parameters and further on the plurality of dynamic posture parameters to obtain an effectiveness signal, and provides at least one feedback instruction based on an analyzed result of the effectiveness signal; and
an output device coupled to the guidance unit, wherein the output device receives the feedback instruction and outputs the at least one feedback instruction, thereby guiding the user to operate the chest compression correctly.

2. The CPR teaching system as claimed in claim 1, wherein the image processing unit further includes:
a feature image extraction and positioning module that performs the analysis computation on the plurality of state image signals and transforms the state image signals into the plurality of posture signals; and
a trajectory tracking module coupled to the feature image extraction and positioning module, wherein the trajectory tracking module performs the analysis computation on the plurality of posture signals and transforms the plurality of posture signals into the trajectory signal to track a motion trajectory of the user in a continuous duration.

3. The CPR teaching system as claimed in claim 2, wherein the feature image extraction and positioning module is based on a skeletal information to identify a plurality of hand feature points of the user and based on the plurality of hand feature points to position a user's palm.

4. The CPR teaching system as claimed in claim 3, wherein the trajectory tracking module analyzes a trajectory of changes of the plurality of hand feature points to perform a trajectory tracking.

5. The CPR teaching system as claimed in claim 2, wherein image processing unit further includes an arm posture detection module, and the arm posture detection module performs the analysis computation on the plurality of state image signals to monitor a user's arm posture.

6. The CPR teaching system as claimed in claim 2, wherein the guidance unit further includes a compression speed computation module and a posture identification and feedback module coupled to the compression speed computation module, in the continuous duration, the posture identification and feedback module analyzes the trajectory signal to obtain the motion trajectory and the plurality of dynamic posture parameters, and the compression speed computation module obtains the effectiveness signal according to the plurality of dynamic posture parameters and one or more standards.

7. The CPR teaching system as claimed in claim 6, wherein the posture identification and feedback module of the guidance unit monitors a user's arm posture in the continuous duration.

8. The CPR teaching system as claimed in claim 6, wherein the output device further includes a speech output unit and an image output unit coupled to the speech output unit, and the image output unit outputs at least one specific images according to the at least one feedback instruction, and the speech output unit outputs at least one speech instruction according to the at least a feedback instruction.

9. A cardiopulmonary resuscitation (CPR) teaching method, applicable to a CPR teaching system having an image input device, a hardware processor having an image processing unit and a guidance unit, and an output device, the method comprising:
receiving, by the image input device, a series of state images of a user;
setting, by an interface to the CPR teaching system, a continuous duration;
using the hardware processor to position a palm of the user and obtain a plurality of feature points of the series of state images, and based on the plurality of feature points, and perform an analysis computation to obtain a posture signal and a trajectory signal;
based on the trajectory signal, using the hardware processor to obtain an effectiveness signal, and determine the effectiveness signal according to a stand to identify whether a compression is an effective compression; and
using the hardware processor to compute a number of effective compressions in the continuous duration, and generate at least one feedback instruction.

10. The CPR teaching method as claimed in claim 9, wherein said using the hardware processor to position the palm of the user further includes:
using the hardware processor to find a direction of elbow-to-forearm of the user, and extend the direction to find a plurality of possible positions and areas of the palm of the user;
using the hardware processor to compute a plurality of image gradients of the plurality of possible positions of the palm of the user;
using the hardware processor to find a position and an area with a maximum image gradient and define the position and the area with the maximum image gradient as the position of the palm of the user; and
after obtaining the position of the palm of the user, using the hardware processor to compute a plurality of pixel computation feature points of the palm of the user.

11. The CPR teaching method as claimed in claim 10, wherein the plurality of pixel computation feature points are implemented by using a plurality of speeded up robust features.

12. The CPR teaching method as claimed in claim 9, wherein said using the hardware processor to obtain the effective signal based on the trajectory signal further includes a step of using the hardware processor to detect a state of performing a chest compression.

13. The CPR teaching method as claimed in claim 12, wherein said using the hardware processor to detect the state of performing the chest compression further includes:
using an optical flow algorithm to track a plurality of hand feature points to obtain a plurality of posture signals representing a dynamic change information of a position of the palm, and generating a palm motion trajectory in a specific continuous duration to generate the trajectory signal;
using a peak detection algorithm to analyze the trajectory signal to obtain a peak of the palm motion trajectory and obtain a compression depth, and determining whether each compression of a number of compressions is an effective compression; and
obtaining the number of effective compressions and a compression speed in the specific continuous duration.

14. A cardiopulmonary resuscitation (CPR) teaching system, comprising:
a memory device storing a plurality of executable instructions; and
a hardware processor executing the plurality of executable instructions to perform:
receiving, by an image input device, to a plurality of dynamic images of a user; using an interface to configure a plurality of system parameters and standard values and wait for the user in a ready state;
when not completing to positioning a palm of the user, executing a palm positioning analysis until positioning the palm of the user being completed;
entering an actual practice and timing phase, wherein the actual practice and timing phase is, for a predefined continuous duration, synchronously and continuously monitoring an operation of the user;
when the user stopping a chest compression operation, giving at least one feedback instruction indicating a failure and terminating the actual practice and timing phase; and
otherwise, continuing monitoring until a number of compressions being reached or a predefined continuous duration being expired.

15. The CPR teaching system as claimed in claim 14, wherein the synchronously and continuously monitoring the operation of the user further includes:
tracking and analyzing a palm motion trajectory analysis, and monitoring and analyzing an arm posture for providing at least one feedback instruction in at least one subsequent step.

16. The CPR teaching system as claimed in claim 14, wherein during the predefined continuous duration, the hardware processor further performs:
monitoring and determining whether an arm posture being correct;
when the arm posture not correct, giving a feedback instruction indicating an incorrect arm posture, and outputting a state image accompanied by an audio instruction to warn the user;
after obtaining an information of the number of compressions and a compression rate, determining whether the compression rate satisfying a predefined standard value; and when the compression rate not satisfying a predefined standard value, outputting the state image accompanied by the audio instruction to warn the user.
